(19) United States
(12) Patent Application Publication
(10) Pub. No.: US 2018/0038271 A1
(43) Pub. Date: Feb. 8, 2018

(54) INTERNAL COMBUSTION ENGINE INTAKE POWER BOOSTER SYSTEM

(71) Applicant: Jetoptera, Inc., Mason, OH (US)

(72) Inventors: Andrei Evulet, Mason, OH (US); John Hawkins, Roslyn, NY (US)

(21) Appl. No.: 15/654,630

(22) Filed: Jul. 19, 2017

Related U.S. Application Data
(60) Provisional application No. 62/371,612, filed on Aug. 5, 2016.

(51) Int. Cl. F02B 33/42; F02B 37/16; F02M 35/10; F02B 13/04

(52) U.S. Cl. CPC F02B 33/42; F02B 13/04; F02B 37/166; F02M 35/10019; F02B 39/10

(57) ABSTRACT

An internal combustion engine includes an intake conduit fluidically coupled to ambient fluid and having an internal cross-sectional area and an engine cylinder fluidically coupled to the intake conduit. A fluidic amplifier is disposed within the intake conduit and is fluidically coupled to the ambient fluid and engine cylinder. The amplifier is further fluidically coupled to a source of primary fluid and is configured to introduce the primary fluid and at least a portion of the ambient fluid to the engine cylinder.

### PRIORITY CLAIM

This application claims priority to U.S. Prov. Pat. Appl. No. 62/371,612 filed Aug. 5, 2016, the contents of which are hereby incorporated by reference in their entirety as if fully set forth herein.

### COPYRIGHT NOTICE

This disclosure is protected under United States and/or International Copyright Laws. © 2017 Jetoptera. All Rights Reserved. A portion of the disclosure of this patent document contains material that is subject to copyright protection. The copyright owner has no objection to the facsimile reproduction by anyone of the patent document or the patent disclosure, as it appears in the Patent and/or Trademark Office patent file or records, but otherwise reserves all copyright rights whatsoever.

### BACKGROUND

An internal combustion engine (ICE) is often compared to an air pump. Horsepower increases with the amount of air flow that is circulated through the system. For a given engine volume, the more air that is supplied to it, the more power is extracted and its efficiency increased. In addition, the more streamlined the exhaust gas flow is, the less power is expended on pushing the exhaust gas out and, thus, the more power is available for propulsion.

Accordingly, the limiting factor to horsepower production is the volume of air that flows through engine. To burn 27 cu. in. (15 oz) of gasoline, for example, requires approximately 262,000 cu. in. of air. If the air flow could be increased by 50%, it would be relatively easy to handle the increase of the fuel flow by 50%, as the latter is much less of a quantity than the amount of air aspirated in the system, and it is in liquid form, i.e. incompressible. Performance air intake and filtration is a significant part of the automotive aftermarket.

Prior art methods of forcing air into the engine are expensive, such as turbochargers or superchargers. With forced induction, some energy is taken—either from the exhaust stream or from the crankshaft—and used to force more air through the induction system (carburetor/throttle-body, manifold and inlet ports) into the cylinder. Conventionally, aspirated engines rely on optimizing air flow through the induction track from the air filter to the far side of the inlet valve.

The aftermarket intakes generally (i) flow better than the stock part due to better filters and more care taken during the manufacturing process, and (ii) pick up cool air to increase the density of the charge. These intakes give an incremental improvement (approximately 5%) for about a $200 cost. The other option is turbo/supercharging, which yields much more power (about double), but at a cost of approximately $4500 in parts (and labor is extra). Examples can be found at http://www.fastforwardsuperchargess.com/miata-superchamer-kit.html. Additionally, both turbo charging and supercharging raise the temperature of the intake air. As a result, there must also be intercoolers to reduce the temperature, adding another layer of complexity and expense.

FIG. 1 illustrates, in a simplified manner, the air in a conventional ICE intake (also known as aspiration) system 101. The inlet 150 may be positioned downstream of an air filter (not shown). An intake air conduit 140 streamlines the air towards the intake valve 130 and into the cylinder 120. With the piston 110 moving downwards, the intake valve 130 opens and air is introduced into the cylinder 120. The amount of the air introduced is typically dependent on the parameters of the engine's design (e.g., effective areas, operation parameters, cylinder and piston geometries, etc.) as well as the pressure distribution and evolution in the air intake system 101. At the end of the intake stroke, the intake valve 130 is closed and the compression begins. The intake valve 130 only opens again at the very end of the exhaust stroke.

### BRIEF DESCRIPTION OF THE DRAWINGS

FIG. 1 illustrates a conventional ICE intake system.

FIG. 2 illustrates one embodiment of the present invention.

FIG. 3 illustrates yet another embodiment of the present invention.

FIG. 4 illustrates yet another embodiment of the present invention.

FIG. 5 illustrates a cross-sectional view of the upper half of a fluidic amplifier according to an embodiment of the present invention.

FIG. 6 illustrates an intake air system with one embodiment of the present invention amplifier placed inside of an intake pipe.

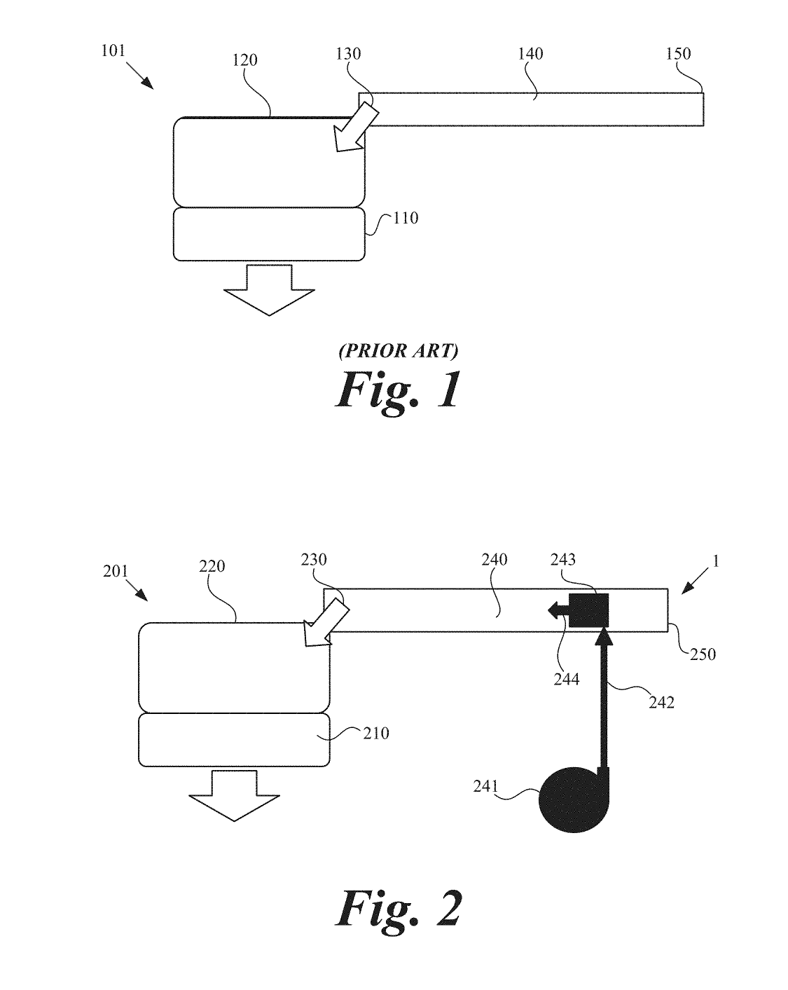

### DETAILED DESCRIPTION OF THE PREFERRED EMBODIMENT

This application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms. In addition, the headings in this application are for reference purposes only and shall not in any way affect the meaning or interpretation of the present invention.

One or more embodiments of the invention disclosed in this application, either independently or working together, act as a fluidic amplifier. Embodiments of the present invention have optionally advantageous features when used with, for example, internal combustion engines (ICEs).

Using embodiments of the present invention, air flow to the cylinders can be increased via retro-fitting a novel fluidic amplifier, which can be cheaper than conventional means. In one embodiment, the ejector device can be integrated into the induction track between the air filter and the throttle-body/carburetor. In this embodiment, high pressure air can be supplied from, for example, a very small exhaust driven turbo or something analogous to the old air-injection emissions pump, in continuous mode, or by using the exhaust gas at high pressure in a pulsed manner.

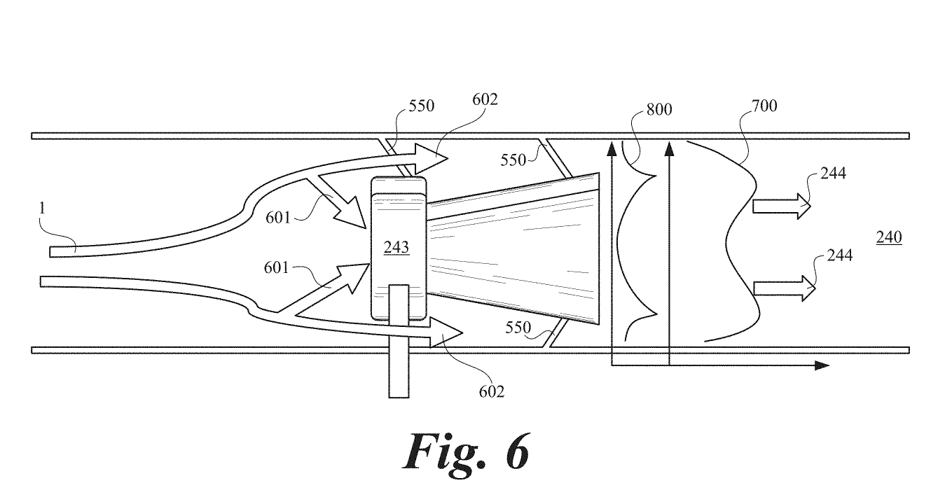

FIG. 2 illustrates a system 201 according to an embodiment of the present invention. A fluidic amplifier, such as an ejector 243, is placed in a conduit 240 having an internal cross-sectional area and augments the flow of air 1 from an intake 250 into a cylinder 220. As best illustrated in FIG. 6, and in an embodiment, ejector 243 occupies less than the internal cross-sectional area of the intake conduit 240 such that at least a portion of air 1 can flow around the ejector within the intake conduit. In varying embodiments, ejector 243 may be placed upstream or downstream of a carburetor/throttle body (not shown). High-pressure air/motive fluid is supplied from a source 241 to the ejector 243 via a conduit 242 to produce a motive stream 244. The introduction of the motive fluid into the ejector 243 can augment the engine air-intake flow 1 by producing a significant reduction of the static pressure in front of the ejector, which allows more air to be delivered from the ambient to the conduit 240 during the entire time motive fluid from source 241 is delivered to the ejector 243.

The cylinder 220 fills with air via an intake valve 230 while the piston 210 is moving downwards. The source 241 may modulate the flow to create a pulsed operation of the ejector 243 such that the motive stream 244 flow is enhanced and/or produced only at the time that the valve 230 is open or other predetermined frequency. In other embodiments, the operation can be continuous and not pulsed.

The source 241 of compressed fluid/air may be a compressor, mechanically and/or electrically driven. The source 241 may also be any other stored or generated high-pressure source within the system. In one embodiment, a pulsed stream of 8 cfm of compressed air from source 241 is released via conduit 242 to the ejector 243, generating an entrainment factor of at least 3 times the additional flow (i.e., 24 cfm) into the cylinder that otherwise would have received less air with a conventional aspiration system. A conventional aspiration system intake is at most RPM 400 cfm. As a result, at max RPM, an embodiment of the present invention can force 6% more air into the system and the engine can produce more power. With no motive air supplied to the ejector 243, no flow other than the naturally aspirated flow is admitted into the cylinder.

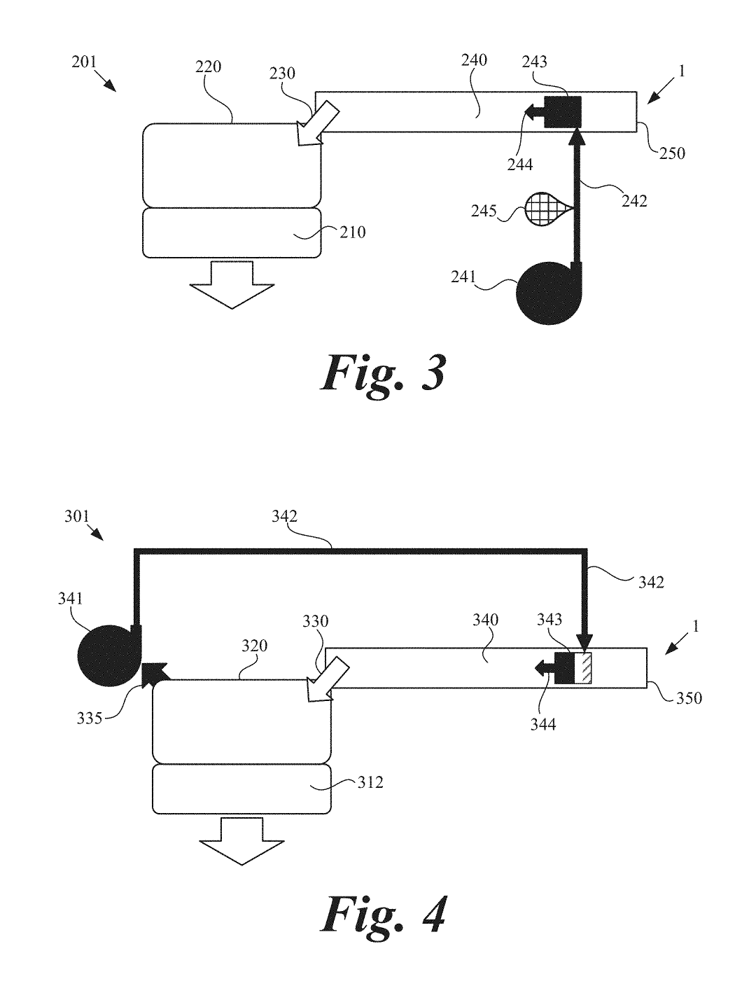

FIG. 3 depicts the system illustrated in FIG. 2, but the stream 244 may contain additional chemicals, such as dimethyl ether (DME), or fuel that improves the mixing of the air and fuel or the combustion well upstream of the intake valve, improving combustion via premixing. The additional chemicals or fuel may be injected in the motive stream 244 via a pressurized tank and delivery system 245.

FIG. 4 depicts a system 301 similar to system 201 illustrated in FIG. 2 and driving piston 312, wherein the motive fluid comprises a small portion (1-5%) of exhaust gas 335 at pressure from an exhaust manifold 341, immediately after the opening of the exhaust valve. Exhaust gas 335, which in various embodiments may complement or completely supplant compressed air from source 241, is routed from the exhaust manifold 341 at pressures up to or exceeding 80 psi and high temperatures, via conduit 342, to the ejector 343, producing a similar augmentation of at least 5% of the flow into the cylinder 320 during intake. The tuning of the length and delivery of the exhaust gas 335 at pressure via conduit 342 is such that it matches the RPM and air intake stage. The emerging mixture of the fresh air naturally aspirated and the augmented portion plus the fraction of the exhaust gas 335 will result in lower oxygen content in the intake. As such, a small portion is continuously recirculated in the system 301, eventually resulting in a stabilized operation of the engine with limited Exhaust Gas Recirculation (EGR) and lowering the peak temperatures in the cylinder 320 end as well as the NOx emissions related to high temperature zones.

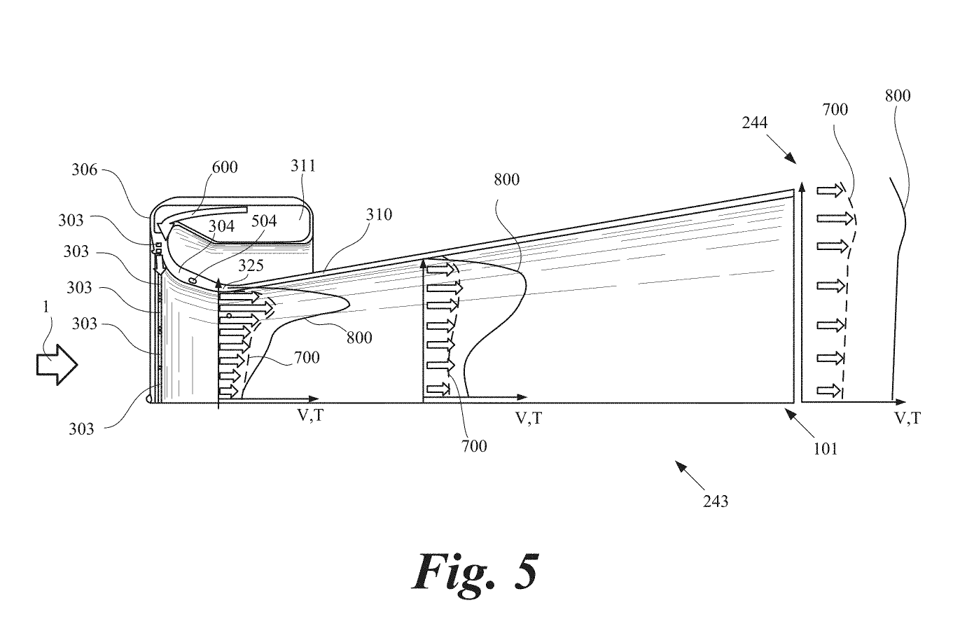

In the embodiment illustrated in FIG. 5, only the upper half of the ejector 243 is shown in cross-sectional view. The fluid flow illustrated in FIG. 5 and discussed below herein is from left to right. A plenum 311 is supplied with hotter-than-ambient air (i.e., a pressurized motive gas stream) from, for example, a combustion-based engine. This pressurized motive gas stream, denoted by arrow 600, is introduced via at least one conduit, such as primary nozzles 303, to the interior of the ejector 243. More specifically, the primary nozzles 303 are configured to accelerate the motive fluid stream 600 to a variable predetermined desired velocity directly over a convex Coanda surface 304 as a wall jet. Coanda surface 304 may have one or more recesses 504 formed therein. Additionally, primary nozzles 303 provide adjustable volumes of fluid stream 600. This wall jet, in turn, serves to entrain through an intake structure 306 secondary fluid, such as intake air, denoted by arrow 1, from intake 250 that may be at rest or approaching the ejector 243 at non-zero speed from the direction indicated by arrow 1. In various embodiments, the nozzles 303 may be arranged in an array and in a curved orientation, a spiraled orientation, and/or a zigzagged orientation.

The mix of the stream 600 and the intake air 1 may be moving purely axially at a throat section 325 of the ejector 243. Through diffusion in a diffusing structure, such as diffuser 310, the mixing and smoothing out process continues so the profiles of temperature 800 and velocity 700 in the axial direction of ejector 243 no longer have the high and low values present at the throat section 325, but become more uniform at the terminal end 100 of diffuser 310. As the mixture of the stream 600 and the intake air 1 approaches the exit plane of terminal end 101, the temperature and velocity profiles are almost uniform. In particular, the temperature of the mixture is low enough to prevent auto-ignition of any fuel remaining inside the exhaust pipe, and the velocity is high enough to reduce the residence time in the carbureting zone. The use of this embodiment of the present invention augments the mass flow rate of the air into the intake of the ICE.

FIG. 6 shows a section of the intake air system with one embodiment of the present invention ejector 243 placed inside of an intake pipe such as conduit 240. In accordance with the embodiment illustrated in FIG. 6, the local exit flow of stream 244 is at higher speed than the velocity of the incoming intake air 1 absent the presence of ejector 243. This is due to the majority of the incoming air 1 coming from the ICE's intake 250 being entrained into the ejector 243 at high velocity, as indicated by arrows 601, due to the lowering of the local static pressure in front of the ejector 243. As indicated by arrows 602, a smaller portion of air 1 bypasses and flows around the ejector 243 and over the mechanical supports 550 that position the ejector in the center of the conduit 240. The ejector 243 vigorously mixes a hotter motive stream provided by the air/gas source 241 (e.g., a compressor) or the pressurized exhaust gas 335 supplied by the exhaust manifold of the ICE, with the incoming intake air 1 stream at high entrainment rate. This mixture is homogeneous enough to increase the temperature of the hot motive stream 244 of the ejector 243 to a mixture temperature profile 800 that will not ignite the air and fuel mixture downstream of the ejector, and before the intake into the cylinder 220. The velocity profile 700 of the stream 244 leaving the ejector 243 is such that it reduces the residence time in the downstream portion of the intake pipe 240, while augmenting the air mass flow rate by at least 10% and up to 50%, preferably at the appropriate timing correlated with the operation of the piston 210.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

We claim:

1. An internal combustion engine, comprising:
an intake conduit fluidically coupled to ambient fluid and having an internal cross-sectional area;
an engine cylinder fluidically coupled to the intake conduit; and
a fluidic amplifier disposed within the intake conduit, the amplifier fluidically coupled to the ambient fluid and engine cylinder, the amplifier further fluidically coupled to a source of primary fluid, the amplifier configured to introduce the primary fluid and at least a portion of the ambient fluid to the engine cylinder.

2. The engine of claim 1, wherein the amplifier occupies less than the internal cross-sectional area of the intake conduit.

3. The engine of claim 1, wherein the amplifier comprises:
a convex surface;
a diffusing structure coupled to the convex surface; and
an intake structure coupled to the convex surface and configured to introduce to the diffusing structure the primary fluid, wherein the diffusing structure comprises a terminal end configured to provide egress from the amplifier for the introduced primary fluid and ambient fluid.

4. The engine of claim 3, wherein the convex surface includes a plurality of recesses.

5. The engine of claim 1, wherein the amplifier is configured to introduce the primary fluid in a pulsed manner at a predetermined frequency.

6. The engine of claim 1, wherein the primary-fluid source comprises an exhaust manifold fluidically coupled to the engine cylinder such that the primary fluid comprises exhaust gas from the engine cylinder.

7. The engine of claim 1, further comprising a reservoir fluidically coupled to the primary-fluid source, the reservoir containing at least one of a combustion-enhancing fuel or chemical.

8. The engine of claim 1, wherein the primary fluid source comprises at least one of a mechanically or turbine-driven compressor.

9. A method of enhancing the performance of an internal combustion engine, the engine having an intake conduit fluidically coupled to ambient fluid and having an internal cross-sectional area, the engine further having a cylinder fluidically coupled to the intake conduit, the method comprising the steps of:
positioning a fluidic amplifier within the intake conduit, such that the amplifier is fluidically coupled to the ambient fluid and engine cylinder; and
fluidically coupling a source of primary fluid to the amplifier, the amplifier configured to introduce the primary fluid and at least a portion of the ambient fluid to the engine cylinder.

10. The method of claim 9, wherein the amplifier occupies less than the internal cross-sectional area of the intake conduit.

11. The method of claim 9, wherein the amplifier comprises:
a convex surface;
a diffusing structure coupled to the convex surface; and
an intake structure coupled to the convex surface and configured to introduce to the diffusing structure the primary fluid, wherein the diffusing structure comprises a terminal end configured to provide egress from the amplifier for the introduced primary fluid and ambient fluid.

12. The method of claim 9, wherein the convex surface includes a plurality of recesses.

13. The method of claim 9, wherein the amplifier is configured to introduce the primary fluid in a pulsed manner at a predetermined frequency.

14. The method of claim 9, further comprising the step of fluidically coupling an exhaust manifold of the engine to the intake conduit such that the primary fluid comprises exhaust gas from the engine cylinder.

15. The method of claim 9, further comprising the step of fluidically coupling a reservoir to the primary-fluid source, the reservoir containing at least one of a combustion-enhancing fuel or chemical.

16. The method of claim 9, wherein the primary fluid source comprises at least one of a mechanically or turbine-driven compressor.
